(19) United States
(12) Patent Application Publication
(10) Pub. No.: US 2025/0078282 A1
(43) Pub. Date: Mar. 6, 2025

(54) STORAGE MEDIUM STORING COMPUTER PROGRAM, PROCESSING METHOD, AND PROCESSING APPARATUS

(71) Applicant: BROTHER KOGYO KABUSHIKI KAISHA, Nagoya (JP)

(72) Inventor: Kentaro SAWANO, Nagoya (JP)

(21) Appl. No.: 18/953,420

(22) Filed: Nov. 20, 2024

Related U.S. Application Data
(63) Continuation of application No. PCT/JP2023/017389, filed on May 9, 2023.

(30) Foreign Application Priority Data
May 27, 2022 (JP) 2022-087277

(51) Int. Cl. G06T 7/174; G06T 7/11; G06T 7/12; G06T 7/194; G06T 7/73; G06T 11/00; G06V 10/764; G06V 20/70

(52) U.S. Cl. CPC G06T 7/174; G06T 7/11; G06T 7/12; G06T 7/194; G06T 7/74; G06T 11/00; G06V 10/764; G06V 20/70; G06T 2207/20021; G06T 2207/20081; G06T 2207/20212

(57) ABSTRACT

A computer that executes a set of program instructions acquires object image data and a plurality of source image data. The object image data indicates an object image including an object. The computer performs a first combining process by using the plurality of source image data to generate background image data indicating a background image. The first combining process includes combining at least some of a plurality of source images. The computer performs a second combining process by using the object image data and the background image data to generate input image data indicating an input image. The second combining process includes combining the background image and the object image where the background image is background and the object image is foreground. The computer performs a particular process including inputting the input image data into a machine learning model and generating output data.

### REFERENCE TO RELATED APPLICATIONS

This is a Continuation Application of International Application No. PCT/JP2023/017389 filed on May 9, 2023, which claims priority from Japanese Patent Application No. 2022-087277 filed on May 27, 2022. The entire content of each of the prior applications is incorporated herein by reference.

### BACKGROUND ART

A machine learning model detects an object region in which an object is arranged in an image and a type of the object, for example.

### SUMMARY

In general, a large amount of image data for training (hereinafter, also referred to as model-training image data) is used for training of a machine learning model.

Preparing a large amount of model-training image data may be a significant burden for training a machine learning model. Such a problem is not limited to the preparation of model-training image data, but is a problem common to the preparation of input image data to be input to a machine learning model.

In view of the foregoing, this specification discloses a new technique that reduces the burden of preparing input image data for input to a machine learning model.

According to one aspect, this specification discloses a non-transitory computer-readable storage medium storing a set of program instructions for a computer. The set of program instructions, when executed by the computer, causes the computer to acquire object image data and a plurality of source image data. The object image data indicates an object image including an object. Each of the plurality of source image data indicates a source image not including the object. The plurality of source image data indicate respective ones of a plurality of source images. Thus, the object image data and the plurality of source image data are acquired. The set of program instructions, when executed by the computer, causes the computer to perform a first combining process by using the plurality of source image data to generate background image data indicating a background image. The first combining process includes combining at least some of the plurality of source images. Thus, the background image data indicating the background image is generated from the plurality of source image data. The set of program instructions, when executed by the computer, causes the computer to perform a second combining process by using the object image data and the background image data to generate input image data indicating an input image. The second combining process includes combining the background image and the object image where the background image is background and the object image is foreground. Thus, the input image data indicating the input image is generated from the object image data and the background image data. The set of program instructions, when executed by the computer, causes the computer to perform a particular process by using the input image data and a machine learning model. The particular process includes inputting the input image data into the machine learning model and generating output data. Thus, the particular process is performed.

According to the above configuration, the input image data to be input to the machine learning model is generated by using the object image data and the plurality of source image data. As a result, a plurality of input image data indicating input images including various backgrounds and objects are easily generated. This reduces the burden of preparing the input image data to be input to the machine learning model.

The technique disclosed in the present specification may be realized in various other modes, and may be realized in the form of, for example, a processing method, a processing apparatus, a method of training a machine learning model, a training apparatus, a computer program for realizing these apparatuses and methods, a storage medium in which the computer program is recorded, and so on.

### BRIEF DESCRIPTION OF DRAWINGS

FIG. 1 is a block diagram showing a configuration of an inspection system 1000.

FIG. 2A is a perspective view of a product 300.

FIG. 2B is an explanatory diagram of a label.

FIG. 3 is a flowchart of an inspection preparation process.

FIG. 4 is a flowchart of a model-training image data generation process.

FIG. 5A shows examples of source images BI.

FIG. 5B shows an example of an artwork image RI.

FIGS. 6A, 6B and 6C are flowcharts of a background generation process.

FIGS. 7A, 7B and 7C show examples of background images MI.

FIGS. 8A, 8B and 8C show examples of images in a model-training image data generation process.

FIG. 9A is an explanatory diagram of an object detection model AN.

FIG. 9B is a flowchart of a training process of the object detection model AN.

FIG. 10A is an explanatory diagram of an image generation model GN.

FIG. 10B is a flowchart of a training process of the image generation model GN.

FIG. 11 is a flowchart of an inspection process.

FIGS. 12A, 12B, 12C, 12D and 12E are diagrams for explaining the inspection process.

### DESCRIPTION

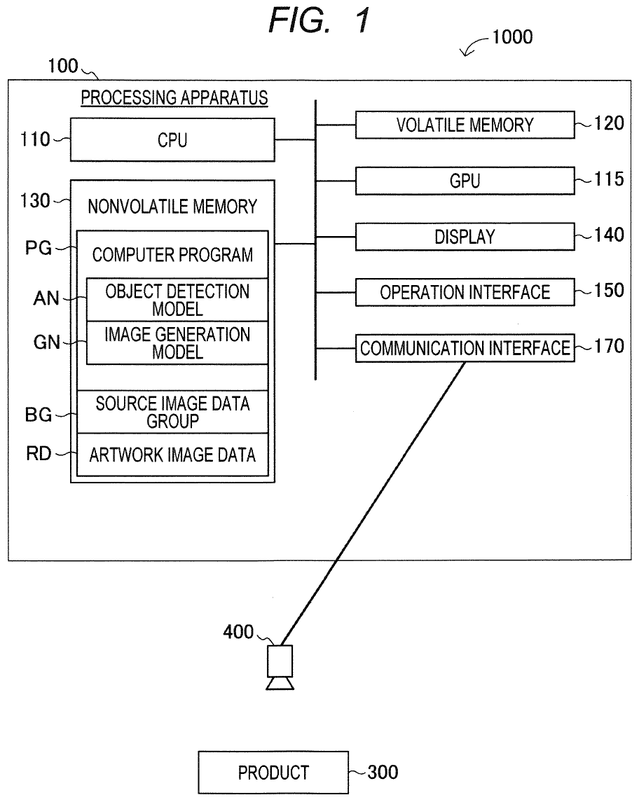

An inspection apparatus according to an embodiment will be described. FIG. 1 is a block diagram showing a configuration of an inspection system 1000 of an embodiment. The inspection system 1000 includes a processing apparatus 100 and an image capturing device (camera) 400. The processing apparatus 100 and the image capturing device 400 are connected so as to communicate with each other.

The processing apparatus 100 is a computer, such as a personal computer, for example. The processing apparatus 100 includes a CPU 110 as a controller of the processing apparatus 100, a GPU 115, a volatile memory 120 such as a RAM, a nonvolatile memory 130 such as a hard disk drive, an operation interface 150 such as a mouse and a keyboard, a display 140 such as a liquid crystal display, and a communication interface 170. The communication interface 170 includes a wired or wireless interface for communicating with an external device such as the image capturing device 400.

The GPU (Graphics Processing Unit) 115 is a processor that performs computation for image processing such as three-dimensional (3D) graphics, according to control of the CPU 110. In this embodiment, the GPU 115 is used in order to perform computation processing of an object detection model AN and an image generation model GN described later.

The volatile memory 120 provides a buffer area for temporarily storing various intermediate data generated when the CPU 110 performs processing. The nonvolatile memory 130 stores a computer program PG, source image data group BG, and artwork image data RD. The source image data group BG includes M source image data (M is an integer of 3 or more, and in the present embodiment, M is a number of approximately 10 to 50). The source image data is used to generate model-training image data in an inspection preparation process described later.

The computer program PG includes, as a module, a computer program by which the CPU 110 and the GPU 115 cooperate and realizes the functions of the object detection model AN and the image generation model GN described later. The computer program PG is provided by the manufacturer of the processing apparatus 100, for example. The computer program PG may be provided in a form downloaded from a server, for example, or may be provided in a form stored in a DVD-ROM and so on. The CPU 110 performs the inspection preparation process and an inspection process described below by executing the computer program PG.

The image capturing device 400 is a digital camera that generates image data (also referred to as captured image data) indicating an image capturing target by capturing the image capturing target by using a two-dimensional image sensor. The captured image data is bitmap data indicating an image including a plurality of pixels, and, specifically, is RGB image data indicating the color for each pixel with RGB values. The RGB values are color values of the RGB color coordinates including gradation values of three color components (hereinafter referred to as component values), that is, R value, G value, and B value. The R value, G value, and B value are gradation values of a particular gradation number (for example, 256), for example. The captured image data may be luminance image data indicating the luminance for each pixel.

The image capturing device 400 generates captured image data and transmits the captured image data to the processing apparatus 100 in accordance with control of the processing apparatus 100. In this embodiment, the image capturing device 400 is used to capture the product 300 on which a label L which is an inspection target of the inspection process is affixed and to generate captured image data indicating a captured image for inspection. The image capturing device 400 may be used to generate the source image data described above.

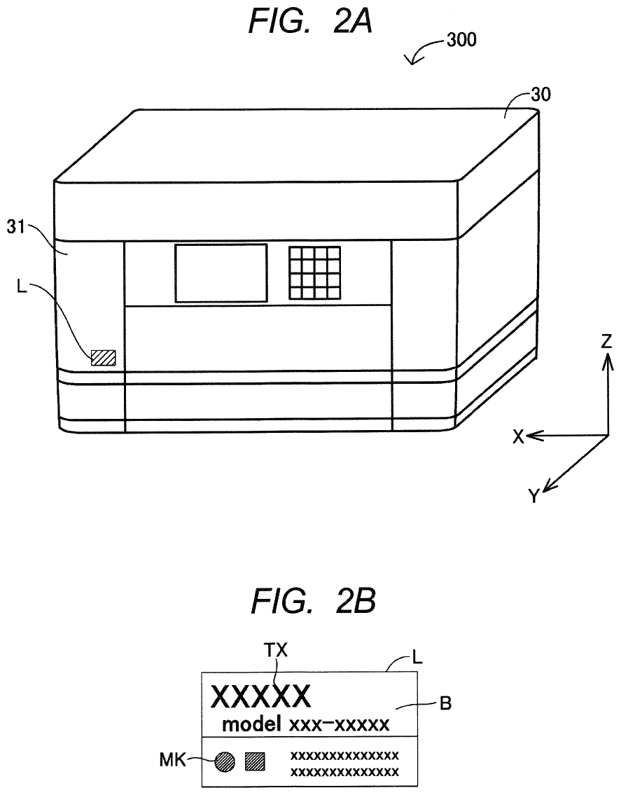

FIG. 2A shows a perspective view of the product 300. The product 300 is a printer including a housing 30 of a substantially rectangular parallelepiped shape in the present embodiment. In a manufacturing process, the rectangular label L is affixed to a front surface 31 (the surface on +Y side) of the housing 30 at a particular affix position.

FIG. 2B shows the label L. The label L includes, for example, a background B, and characters TX and marks MK indicating various kinds of information such as a brand logo of a manufacturer or a product, a model number, and a lot number.

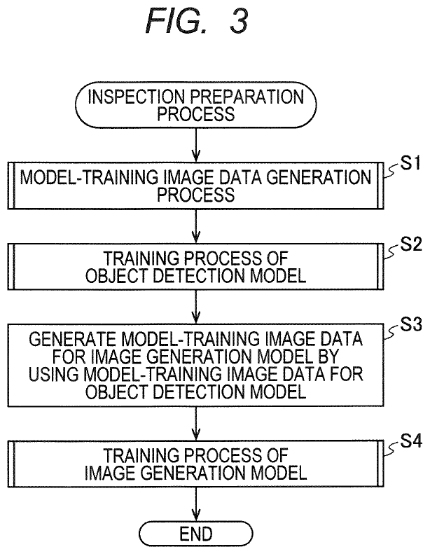

The inspection preparation process is performed before the inspection process (described later) for inspecting the label L. The inspection preparation process includes training of the machine learning models (the object detection model AN and the image generation models GN) used by the inspection process. FIG. 3 is a flowchart of the inspection preparation process.

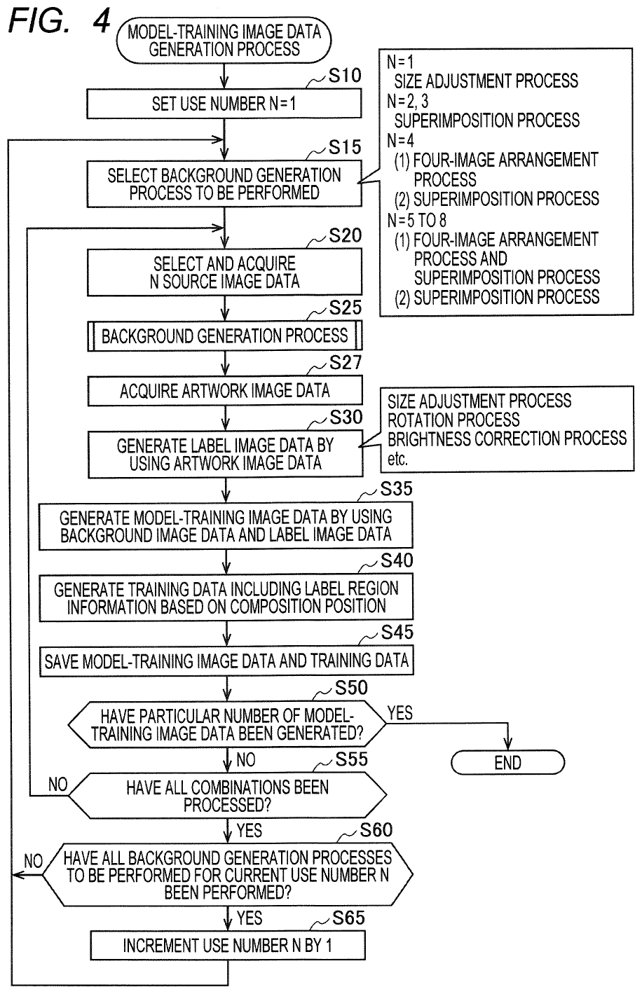

In S1, the CPU 110 performs a model-training image data generation process. The model-training image data generation process is a process of generating model-training image data, which is image data used for training of the machine learning model, by using the artwork image data RD and the source image data group BG. FIG. 4 is a flowchart of the model-training image data generation process.

In S10, the CPU 110 sets a number of source image data N used to generate one model-training image data (hereinafter also referred to as a use number N) to 1, which is an initial value.

In S15, based on the use number N, the CPU 110 selects a background generation process to be performed. The background generation process is a process of generating background image data indicating one background image by using N source image data. As shown in FIG. 4, in a case where the use number N is 1, the background generation process is determined to be a size adjustment process. In a case where the use number N is 2 or 3, the background generation processing is determined to be a superimposition process. In a case where the use number N is 4, the background generation process is first determined to be a four-image arrangement process, and then determined to be the superimposition process. In a case where the use number N is any of 5 to 8, the background generation process is first determined to be a process combining the four-image arrangement process and the superimposition process, and then determined to be the superimposition process. These background generation processes will be described later.

In S20, the CPU 110 selects and acquires N source image data from the M source image data included in the source image data group BG. The number of combinations of selecting the N source image data from the M source image data is MCN (M choose N, that is, the number of combinations of M objects taken N at a time). One combination is sequentially selected from the MCN combinations.

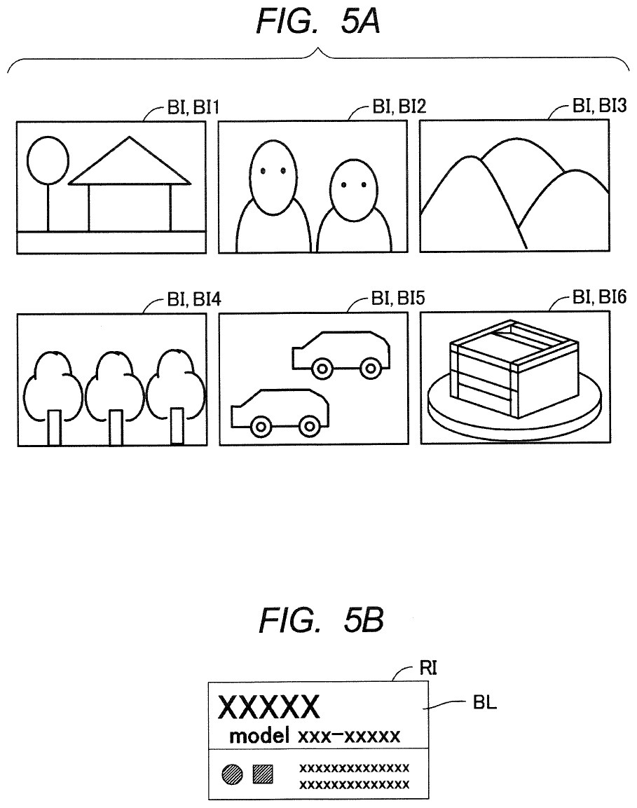

FIGS. 5A and 5B show examples of source images BI indicated by source image data and an example of an artwork image RI indicated by the artwork image data RD. FIG. 5A illustrates six types of source images BI1 to BI6. The source image data is captured image data generated by capturing an image of a particular subject using a digital camera (for example, the image capturing device 400). The source image data is bitmap data indicating an image including a plurality of pixels, and specifically, is RGB image data representing a color of each pixel by RGB values. The M source images BI (for example, the source images BI1 to BI6) are images indicating various subjects (for example, a person, an artificial object, scenery, an animal or plant, or a combination thereof).

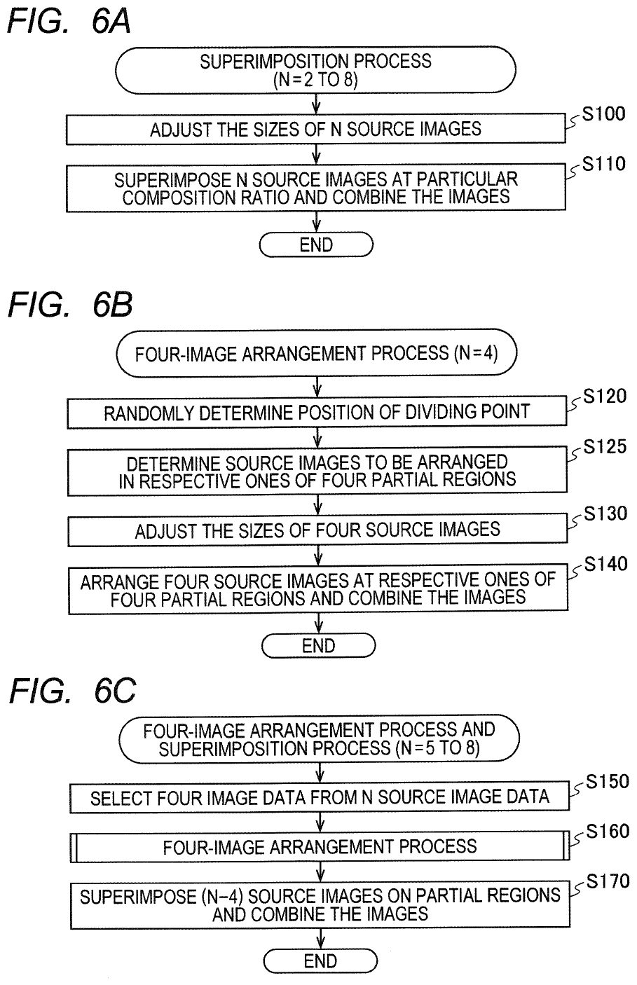

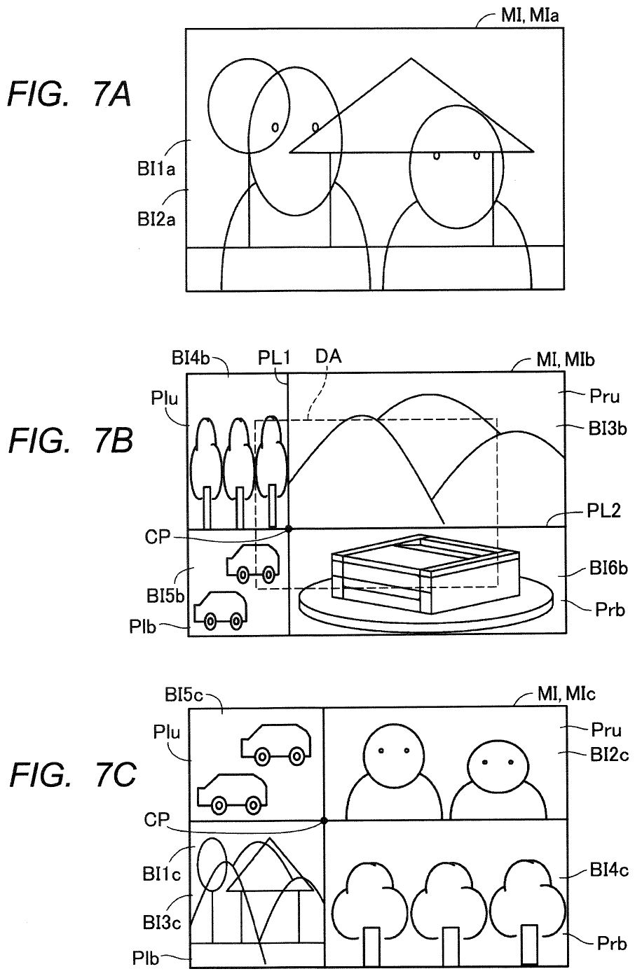

In S25, the CPU 110 performs a background generation process. The background generation process is a process of generating background image data indicating a background image MI by using the selected N source image data. FIGS. 6A to 6C show flowcharts of the background generation process. FIGS. 7A to 7C show examples of the background image MI. The background generation process to be performed is a process that has been determined in S15. The background generation process to be performed is any one of the size adjustment process, the superimposition process, the four-image arrangement process, and a combination of the four-image arrangement process and the superimposition process, as described above.

In the size adjustment process performed when the use number N is 1 (not shown), the CPU 110 performs a reduction or enlargement process on the selected one source image data. Due to this process, the size of one source image BI is adjusted to a predetermined size (the number of pixels in the vertical direction and the horizontal direction) of the input image that is input to the object detection model AN. In this case, the size-adjusted source image data is one background image data.

FIG. 6A shows a flowchart of the superimposition process performed when the use number N is 2 to 8. In S100, the CPU 110 performs a reduction or enlargement process on each of the N source image data to adjust the size of each of the N source images BI to the predetermined size.

In S110, the CPU 110 superimposes and combines the N source images BI at a particular composition ratio to generate background image data indicating one background image MI. For example, the composition ratio is (1/N), for example.

FIG. 7A illustrates a background image MIa generated by using the two source images BI1 and BI2 of FIG. 5A in a case where the use number is 2. The values (Ro, Go, Bo) of a particular pixel of the background image MIa are expressed by the following formula using values (Ri1, Gi1, Bi1) and (Ri2, Gi2, Bi2) of the corresponding pixels of the two source images BI, that is, Ro=(1/2)Ri1+(1/2)Ri2, Go=(1/2)Gi1+(1/2)Gi2, and Bo=(1/2)Bi1+(1/2)Bi2.

In this way, in the superimposition process, in the background image MIa to be generated, the values of the pixels in a superimposed region (for example, the entire background image MIa) where the two source images BI1 and BI2 are superimposed on each other are calculated using both the values of the pixels of the source image BI1 and the values of the pixels of the source image BI2.

FIG. 6B shows a flowchart of the four-image arrangement process performed when the use number N is four. FIG. 7B illustrates a background image MIb generated by using the four source images BI3 to BI6 of FIG. 5B.

In S120, the CPU 110 determines the position of a dividing point CP in the background image MI to be generated. Since the background image MI to be generated has a predetermined size of the input image that is input to the object detection model AN, the position of the dividing point CP is determined in an image of that size. The position of the dividing point CP is determined randomly within a particular range DA set in the background image MI to be generated. The particular range DA is, for example, a rectangular range having the same center as the center of the background image MI and having a width and a height of approximately 60% to 80% of the width and the height of the background image MI.

By determining the dividing point CP, the background image MI is divided into four partial regions. For example, as shown in FIG. 7B, the background image MI is divided into four partial regions Pru, Prb, Plu, and Plb by a dividing line PL1 passing through the dividing point CP and extending in the vertical direction and a dividing line PL2 passing through the dividing point CP and extending in the horizontal direction.

In S125, the CPU 110 determines the source images BI to be arranged in the four partial regions Pru, Prb, Plu, and Plb. For example, the four source images BI selected in S20 of FIG. 4 are randomly allocated to respective ones of the four partial regions Pru, Prb, Plu, and Plb. In the example of FIG. 7B, the source image BI3 (FIG. 5A) is allocated to the upper right partial region Pru, and the source image BI6 (FIG. 5A) is allocated to the lower right partial region Prb. The source image BI4 (FIG. 5A) is allocated to the upper left partial region Plu, and the source image BI5 (FIG. 5A) is allocated to the lower left partial region Plb.

In S130, the CPU 110 performs a reduction or enlargement process on each of the four source image data, and adjusts the size of each of the four source images BI to the size of the allocated partial region. The ratio of reduction or enlargement in the vertical direction and the horizontal direction of the four source images BI is determined according to the number of pixels in the vertical direction and the horizontal direction of the allocated partial region. Since the size of each partial region depends on the dividing point CP determined randomly, the aspect ratio (vertical-to-horizontal ratio) of each partial region also varies randomly. Thus, the aspect ratio of the size-adjusted source image BI also varies according to the aspect ratio of the partial region. For example, in the example of FIG. 7B, the size-adjusted source images BI3b, BI6b, BI4b, and BI5b are shown. The aspect ratios of the size-adjusted source images BI3b, BI6b, BI4b, and BI5b are different from the aspect ratios of the source images BI3, BI6, BI4, and BI5 before size adjustment (FIG. 5A).

In S140, the CPU 110 generates background image data indicating one background image MI by arranging and combining four source images BI in four divided regions. For example, in the background image MIb of FIG. 7B, the four size-adjusted source images BI3b, BI6b, BI4b, and BI5b are arranged in the allocated regions of the four partial regions Pru, Prb, Plu, and Plb, respectively. In this way, in the four-image arrangement process, data indicating an image in which four source images are arranged is generated as background image data.

FIG. 6C shows a flowchart of a process in which the four-image arrangement process and the superimposition process are combined, which is performed when the use number N is any of 5 to 8. FIG. 7C shows a background image MIc generated by using the five source images BI1 to BI5 of FIG. 5A.

In S150, the CPU 110 selects four source image data from the N source image data selected in S20 of FIG. 4. This selection is performed, for example, randomly.

In S160, the CPU 110 performs the four-image arrangement process (FIG. 6B) by using the four source image data selected in S150. By this, image data indicating an arrangement image (not shown) in which four source images BI are arranged is generated. For example, in the example of the background image MIc of FIG. 7C, the CPU 110 performs the four-image arrangement process by using four source images BI2 to BI5 among the five source images BI1 to BI5, and generates an image in which the four size-adjusted source images BI2c to BI5c are arranged.

In S170, the CPU 110 generates background image data indicating the background image MI by superimposing and combining each of the remaining (N-4) source images BI on the partial region of the arrangement image. The (N-4) source images BI are source images BI represented by (N-4) source image data that have not been selected in S150, among the N source image data. In the example of the background image MIc of FIG. 7C, the size-adjusted source image BI1c based on the remaining source image BI1 among the five source images BI1 to BI5 is arranged and superimposed at the lower left partial region Plb. As a result, the image in the lower left partial region Plb of the background image MIc in FIG. 7C is an image acquired by superimposing the source image BI3c arranged by the four-image arrangement process and the source image BI1c. The process of superimposing the source image BI3c and the source image BI1c is the same process as the process of superimposing two source images BI3b (S110 in FIG. 6 and FIG. 7A) in the superimposition process of FIG. 6A. The images in the other three partial regions Pru, Prb, and Plu of the background image MIc of FIG. 7C are the source images BI2c, BI4c, and BI5c arranged by the four-image arrangement process, respectively.

In S27 after the background image data is generated in S25 of FIG. 4, the CPU 110 acquires the artwork image data RD from the nonvolatile memory 130. In S30, the CPU 110 generates label image data indicating a label image LI by using the artwork image data RD.

FIG. 5B illustrates the artwork image RI represented by the artwork image data RD. The artwork image RI is an image showing the label BL. The label shown in the artwork image RI is denoted by a reference sign “BL” for distinguishing from the actual label L. The label BL is a computer graphics (CG) image indicating the actual label L. The artwork image data RD is bitmap data similar to the captured image data, and is RGB image data in the present embodiment. The artwork image data RD is data used for producing the label L. For example, the label L is produced by printing the artwork image RI represented by the artwork image data RD on a sheet for label.

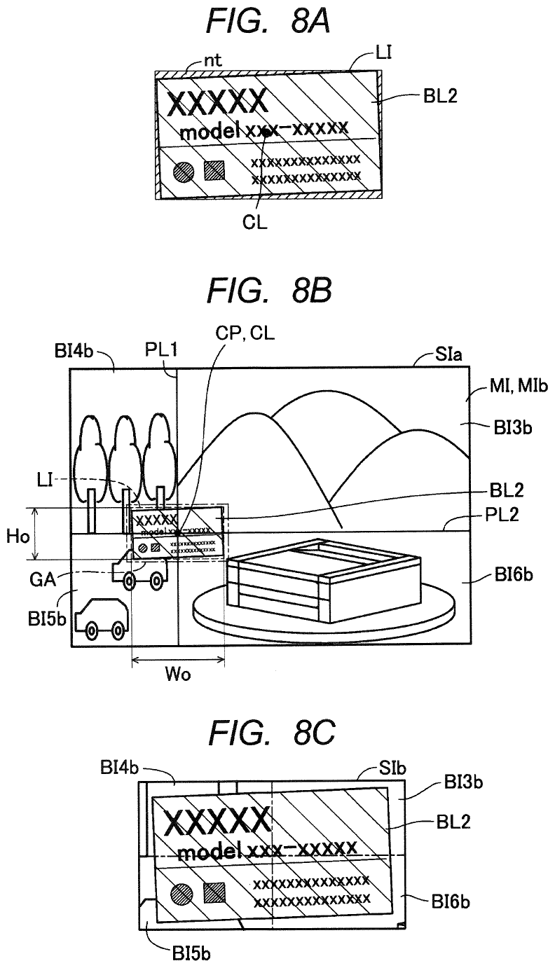

FIGS. 8A to 8C show examples of images in the model-training image data generation process. FIG. 8A shows an example of the label image LI. The CPU 110 performs particular image processing including a size adjustment process, a rotation process, and a brightness correction process on the artwork image data RD, for example, to generate label image data indicating the label image LI shown in FIG. 8A. The particular image processing is processing for adjusting the artwork image RI, which is a CG image, to an image having visual like a captured label.

The size adjustment process is a process of adjusting the size of an image to a size of a particular range smaller than the background image MI, and is a process of reducing or enlarging the image. The rotation processing is, for example, processing of rotating an image by a particular rotation angle. The particular rotation angle is determined randomly within a range of −3 degrees to +3 degrees, for example. The brightness correction process is processing of changing the brightness of an image. For example, the brightness correction process is performed by converting each of three component values (R value, G value, and B value) of the RGB value of each pixel using a gamma curve. The γ value of the gamma curve is determined randomly within a range of 0.7 to 1.3, for example. The particular image processing may include other image processing such as a smoothing process or a noise addition process, together with these processes or instead of all or some of these processes.

As shown in FIG. 8A, the label image LI acquired by performing the particular image processing on the artwork image RI is an image that expresses a captured label in a pseudo manner. Due to the rotation process described above, gaps nt are formed between the four sides of the label image LI and the four sides of a label BL2. The regions of the gaps nt are filled with pixels of a particular color, for example, white.

In S35, the CPU 110 generates model-training image data indicating a training image SIa by using the background image data and the label image data. Specifically, the CPU 110 performs a combining process of combining the label image LI (for example, FIG. 8A) with the background image MI (for example, FIGS. 7A and 7B).

In the combining process, the CPU 110 generates an alpha channel which is information defining a transparency α (alpha), for each of the plurality of pixels of the label image LI. The transparency α of the pixels constituting the labels BL2 of the label image LI (FIG. 8A) is set to 1 (0%), and the transparency α of the pixels constituting the gaps nt is set to 0 (100%).

The CPU 110 determines the position to combine (arrange) the label image LI with respect to the background image MI. In a case where the background image MI is the background image MIa (FIG. 7A) generated by the superimposition process, a composition position of the label image LI is randomly determined to be a position where the entire label image LI is arranged, for example. In a case where the background image MI is the background image MIb or MIc (FIG. 7B or 7C) generated by the process including the four-image arrangement process, the composition position of the label image LI is determined to be a position where the dividing point CP (FIG. 7B or 7C) of the background image MI and a center CL (FIG. 8A) of the label image LI match.

The CPU 110 identifies pixels on the background image MI that overlap with pixels (pixels for which the transparency α is set to 1) that constitute the label BL2 of the label image LI in a case where the label image LI is arranged at the composition position on the background image MI. The CPU 110 replaces the values of the plurality of pixels of the identified background image MI with the values of the plurality of corresponding pixels of the label image LI. As a result, model-training image data indicating the training image SIa (FIG. 8B) is generated. The training image SIa is acquired by combining the background image MI and the label image LI (the label BL2), where the background image MI is the background and the label image LI is the foreground.

In a case where the background image MI is generated by the process including the four-image arrangement process, as shown in FIG. 8B, in the training image SIa, the label image LI is arranged on the boundary between the plurality of source images BI3b to BI6b arranged in the background image MI.

In S40, the CPU 110 generates training data including label region information, based on the composition position where the label image LI is combined (arranged) with respect to the background image MI when the model-training image data is generated. Specifically, the CPU 110 generates the label region information including a width (horizontal size) Wo and a height (vertical size) Ho of the region where the label image LI is combined (arranged) in the training image SIa (FIG. 8B) and the coordinates of the center CL of the region. The width and height of the label image LI before the composition are used as the width Wo and the height Ho. The CPU 110 generates training data including the label region information and information such as class information described below. The training data corresponds to output data OD of the object detection model AN. Thus, when the object detection model AN is described later, the training data will be supplementarily described.

In S45, the CPU 110 saves (stores) the model-training image data generated in S35 and the training data generated in S45 in the nonvolatile memory 130 in association with each other.

In S50, the CPU 110 determines whether a particular number P of model-training image data have been generated. The particular number P is, for example, the number of model-training image data necessary for training the object detection model AN, and is several thousands to several tens of thousands. In a case where the particular number P of model-training image data have been generated (S50: YES), the CPU 110 ends the model-training image data generation process. In a case where the particular number P of model-training image data have not been generated (S50: NO), the CPU 110 advances the processing to S55.

In S55, the CPU 110 determines whether all combinations of N source image data have been processed. That is, the CPU 110 determines whether MCN model-training image data have been generated by using all of the MCN combinations. In a case where there is an unprocessed combination (S55: NO), the CPU 110 returns the processing to S20 and selects N source image data of an unprocessed combination. In a case where all the combinations have been processed (S55: YES), the CPU 110 advances the processing to S60.

In S60, the CPU 110 determines whether all background generation processes to be performed for the current use number N have been performed. For example, as shown in FIG. 4, in a case where the use number N is any one of 1 to 3, the background generation processing to be performed is one type. Thus, in a case where the use number N is any of 1 to 3, the CPU 110 determines in this step that all the background generation processes to be performed have been performed. In a case where the use number is any of 4 to 8, there are two types of background generation process to be performed. For example, in a case where the use number is four, the background generation process to be performed is two types, that is, the four-image arrangement processing and the superimposition process. In this case, at the time when the four-image arrangement process to be performed first is completed for all the combinations, the superimposition process to be performed later has not been performed yet. Thus, in this case, the CPU 110 determines in this step that there is an unprocessed background generation process to be performed. After the superimposition process to be performed later is completed for all the combinations, the CPU 110 determines in this step that the background generation process to be performed has been performed for all the combinations.

In a case where it is determined that there is an unprocessed background generation process to be performed (S60: NO), the CPU 110 returns the processing to S15 and selects the unprocessed background generation process (in the present embodiment, the superimposition process). In a case where all the background generation processes to be performed have been performed (S60: YES), in S65 the CPU 110 increments the use number N by one, and returns the processing to S15.

As can be seen from the above description, the model-training image data generation process ends at the time when the particular number P of model-training image data have been generated (YES in S50 of FIG. 4). Thus, the use number N until which the model-training image data generation process is continued is determined by the number M of source image data that is prepared and the number (particular number P) of necessary model-training image data. Thus, depending on the number M of source image data that is prepared and the number P of necessary model-training image data, the model-training image data generation process may end at the time when the use number N is 4, or the model-training image data generation process may be continued until the use number N is 8. In the present embodiment, it is assumed that the number M of source image data that is prepared and the number P of necessary model-training image data are such numbers that the model-training image data generation process ends before the use number N becomes 9.

In S2 after the end of the model-training image data generation process in S1 of FIG. 3, a training process of the object detection model AN is performed. The outline of the machine learning model AN and the training process will be described below.

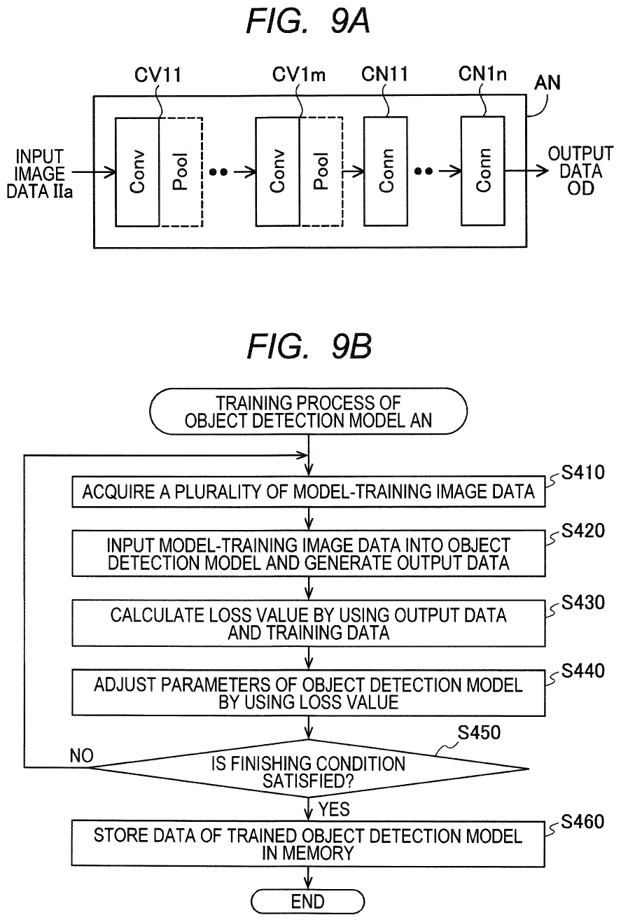

FIG. 9A is a schematic diagram showing an example of a configuration of the object detection model AN. Various object detection models may be adopted as the object detection model AN. In the present embodiment, the object detection model AN is an object detection model called YOLO (You only look once). The YOLO is disclosed, for example, in the article “Joseph Redmon, Santosh Divvala, Ross Girshick, Ali Farhadi, “You Only Look Once: Unified, Real-Time Object Detection”, Proceedings of the IEEE Conference on Computer Vision and Pattern Recognition (CVPR), 2016, pp. 779-788”. The YOLO model predicts a region where an object in an image is located and a type of the object located in the region by using a convolutional neural network.

As shown in FIG. 9A, the object detection model AN includes m (m is an integer of 1 or more) convolution layers CV11 to CV1m and n (n is an integer of 1 or more) fully connected layers CN11 to CN1n following the convolution layers CV11 to CV1m. Here, m is 24, for example, and n is 2, for example. A pooling layer is provided immediately after one or more convolution layers of the m convolution layers CV11 to CV1m.

The convolution layers CV11 to CV1m perform processing including a convolution process and a bias addition process on data that is input. The convolution process is a process of sequentially applying t filters to input data and calculating a correlation value indicating a correlation between the input data and the filters (t is an integer of 1 or more). In the process of applying the filter, a plurality of correlation values are sequentially calculated while sliding the filter. The bias addition process is a process of adding a bias to the calculated correlation value. One bias is prepared for each filter. The dimension of the filters and the number of filters t are usually different among the m convolution layers CV11 to CV1m. Each of the convolution layers CV11 to CV1m has a parameter set including a plurality of weights and a plurality of biases of a plurality of filters.

The pooling layer performs a process of reducing the number of dimensions of data on the data input from the convolution layer immediately before. As the pooling process, various processes such as average pooling and maximum pooling may be used. In the present embodiment, the pooling layer performs maximum pooling. The maximum pooling reduces the number of dimensions by sliding a window of a particular size (for example, 2×2) by a particular stride (for example, 2) and selecting the maximum value in the window.

The fully connected layers CN11 to CN1n use f dimensional data (that is, f values) that are input from the previous layer to output g dimensional data (that is, g values). Here, f is an integer of 2 or more, and G is an integer of 2 or more. Each of the g output values is a value acquired by adding a bias to the inner product of a vector formed by the f input values and a vector formed by the f weights. The number of dimensions f of the input data and the number of dimensions g of the output data are usually different among the n fully-connected layers CN11 to CN1n. Each of the fully connected layers CN11 to CN1n has parameters including a plurality of weights and a plurality of biases.

The data generated by each of the convolution layers CV11 to CV1m and the fully connected layers CN11 to CN1n is input to an activation function and converted. Various functions may be used as the activation function. In the present embodiment, a linear activation function is used for the last layer (here, the fully connected layer CN1n), and a leaky rectified linear unit (LReLU) is used for the other layers.

An outline of the operation of the object detection model AN will be described. Input image data IIa is input to the object detection model AN. In the present embodiment, in the training process, model-training image data indicating the training image SIa (FIG. 8B) is input as the input image data IIa.

When the input image data IIa is input, the object detection model AN performs arithmetic processing using the above-described parameter set on the input image data IIa to generate the output data OD. The output data OD is data including S×S×(Bn×5+C) prediction values. Each prediction value includes prediction region information indicating a prediction region (also referred to as a bounding box) in which an object (a label in the present embodiment) is predicted to be located, and class information indicating a type (also referred to as a class) of an object existing in the prediction region.

Bn pieces of prediction region information are set for each of S×S cells acquired by dividing an input image (for example, the composite image CI) into S×S images. Here, Bn is an integer of 1 or more, for example, 2. S is an integer of 2 or more, for example, 7. Each prediction region information includes five values of center coordinates (Xp, Yp), a width Wp, a height Hp of the prediction region with respect to the cell, and a confidence Vc. The confidence Vc is information indicating a probability that an object exists in the prediction region. The class information is information indicating the type of an object existing in a cell by the probability of each type. The class information includes values indicating C probabilities in a case where the types of the objects are classified into C types. Here, C is an integer of 1 or more. In this embodiment, C=1 and whether the object is label is discriminated. Thus, the output data OD includes S×S×(Bn×5+C) prediction values as described above.

The training data generated in S40 of FIG. 4 corresponds to the output data OD. Specifically, the training data indicates ideal output data OD to be output when corresponding model-training image data is input to the object detection model AN. That is, as an ideal prediction value corresponding to a cell in which the center of the label BL2 (label image L1) is located in the training image SIa (FIG. 8B) among the S×S×(Bn×5+C) prediction values, the training data includes the label region information, the maximum confidence Vc (for example, 1), and the class information indicating that the object is the label. Further, the training data includes a minimum confidence Vc (for example, 0) as a prediction value corresponding to a cell in which the center of the label BL2 is not located.

Next, a training process (S2 in FIG. 3) of the object detection model AN will be described. FIG. 9B is a flowchart of the training process of the object detection model AN. The object detection model AN is trained such that the output data OD indicates an appropriate label region of the input image (for example, the training image SIa). By training, a plurality of parameters used for the operation of the object detection model AN (including a plurality of parameters used for the operation of each of the plurality of layers CV11 to CV1m and CN11 to CN1n) are adjusted. Before the training process, the plurality of parameters are set to initial values such as random values.

In S410, the CPU 110 acquires a plurality of model-training image data of a batch size from a particular number P of model-training image data stored in the nonvolatile memory 130. In S420, the CPU 110 inputs the plurality of model-training image data to the object detection model AN, and generates a plurality of output data OD corresponding to the plurality of model-training image data.

In S430, the CPU 110 calculates a loss value using the plurality of output data OD and a plurality of training data corresponding to the plurality of output data OD. Here, the training data corresponding to the output data OD means the training data stored in S45 of FIG. 4 in association with the model-training image data corresponding to the output data OD. The loss value is calculated for each model-training image data.

A loss function is used to calculate the loss value. The loss function may be various functions for calculating a loss value corresponding to a difference between the output data OD and the training data. In the present embodiment, the loss function disclosed in the above-mentioned YOLO paper is used. The loss function includes, for example, a region loss term, an object loss term, and a class loss term. The region loss term is a term that calculates a smaller loss value as the difference between the label region information included in the training data and the corresponding prediction region information included in the output data OD is smaller. The prediction region information corresponding to the label region information is prediction region information associated with the cell associated with the label region information among the plurality of prediction region information included in the output data OD. The object loss term is a term that calculates a smaller value as the difference between the value (0 or 1) of the training data and the value of the output data OD is smaller, regarding the confidence Vc of each prediction region information. The class loss term is a term that calculates a smaller loss value as the difference between class information included in the training data and corresponding class information included in the output data OD is smaller. The corresponding class information included in the output data OD is class information associated with the cell associated with the class information of the training data among the plurality of class information included in the output data OD. As a specific loss function of each term, a known loss function for calculating a loss value corresponding to a difference, for example, a square error, a cross entropy error, or an absolute error is used.

In S440, the CPU 110 adjusts a plurality of parameters of the object detection model AN by using the calculated loss value. Specifically, the CPU 110 adjusts the parameters in accordance with a particular algorithm such that the total of the loss values calculated for each of the model-training image data becomes small. As the particular algorithm, for example, an algorithm using the error backpropagation method and the gradient descent method is used.

In S450, the CPU 110 determines whether a finishing condition of training is satisfied. The finishing condition may be various conditions. The finishing condition is, for example, that the loss value becomes less than or equal to a reference value, that the amount of change in the loss value becomes less than or equal to a reference value, or that the number of times the adjustment of the parameter of S440 is repeated becomes greater than or equal to a particular number.

In a case where the finishing condition of the training is not satisfied (S450: NO), the CPU 110 returns the processing to S410 and continues the training. In a case where the finishing condition of the training is satisfied (S450: YES), the CPU 110 stores the trained object detection model AN including the adjusted parameters in the nonvolatile memory 130 in S460, and ends the training process.

The output data OD generated by the trained object detection model AN has the following characteristics. In the output data OD, one of the prediction region information associated with the cell including the center of the label in the input image includes information appropriately indicating the region of the label in the input image and a high confidence Vc (the confidence Vc close to 1). In the output data OD, the class information associated with the cell including the center of the label in the input image indicates that the object is the label. The other prediction region information included in the output data OD includes information indicating a region different from the region of the label and a low confidence Vc (the confidence Vc close to 0). Thus, the region of the label in the input image is identified by using the prediction region information including the high confidence Vc.

In S3 of FIG. 3 after the training process, the CPU 110 generates model-training image data for the image generation model GN by using model-training image data for the machine learning model AN. FIG. 8C illustrates a training image SIb represented by model-training image data for the image generation model GN. The model-training image data for the image generation model GN is generated by performing a trimming process on the model-training image data for the machine learning model AN. As shown in FIG. 8C, the training image SIb for the image generation model GN is acquired by cutting out an image in a particular region GA including the entire label BL2 from the training image SIa (FIG. 8B) for the machine learning model AN. The particular region GA is, for example, a rectangular region whose center is the center CL (which is also the dividing point CP of the training image SIa) of the combined label image LI. The particular region GA is slightly larger than the label image LI. As shown in FIG. 8C, the training image SIb for the image generation model GN is an image including the entire label BL2 and a part of each of the source images BI3b to BI6b as the background of the label BL2.

In S4, the CPU 110 performs a training process of the image generation model GN. Hereinafter, an outline of the image generation model GN and the training process will be described.

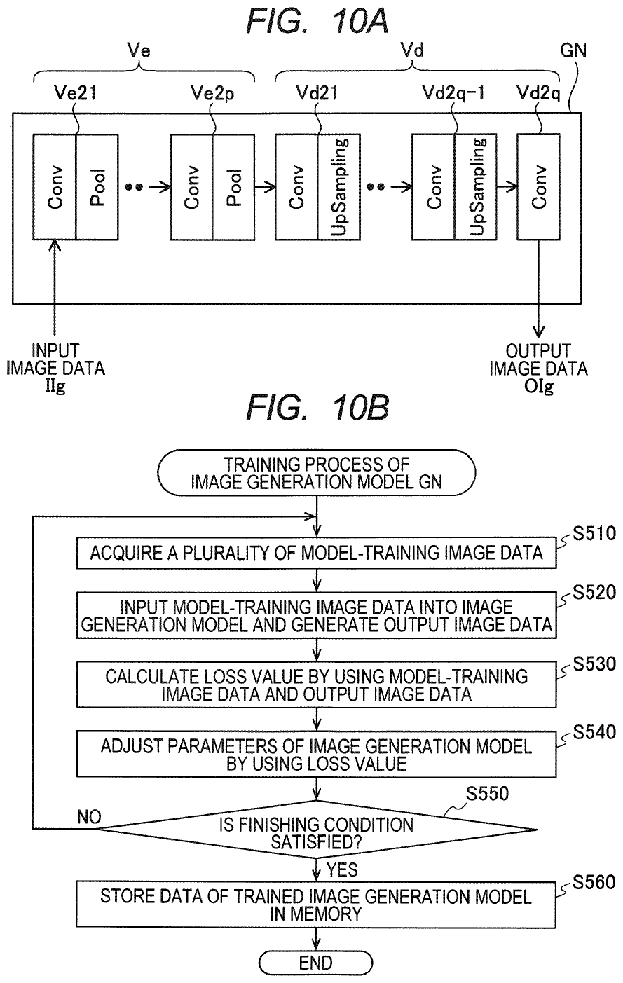

FIG. 10A is a schematic diagram showing an example of the configuration of the image generation model GN. In the present embodiment, the image generation model GN is a so-called autoencoder, and includes an encoder Ve and a decoder Vd.

The encoder Ve performs a dimension reduction process on input image data IIg indicating an image of an object and extracts a feature of the input image (for example, the training image SIb in FIG. 8C) indicated by the input image data IIg to generate feature data. In the present embodiment, the encoder Ve includes p convolution layers Ve21 to Ve2p (m is an integer of 1 or more). A pooling layer (for example, a max-pooling layer) is provided immediately after each convolution layer. The activation function of each of the p convolution layers is ReLU, for example.

The decoder Vd performs a dimension restoration process on the feature data to generate output image data OIg. The output image data OIg represents an image reconstructed based on the feature data. The image size of the output image data OIg and the color components of the color value of each pixel of the output image data OIg are the same as those of the input image data IIg.

In the present embodiment, the decoder Vd includes q (q is an integer of 1 or more) convolution layers Vd21 to Vd2q. An upsampling layer is provided immediately after each of the convolution layers except for the last convolution layer Vd2q. The activation function of the last convolution layer Vd2q is a function suitable for generating the output image data OIg (for example, a sigmoid function or a Tanh function). The activation function of each of the other convolution layers is ReLU, for example.

The convolution layers Ve21 to Ve2p and Vd21 to Vd2q perform processing including a convolution process and a bias addition process on the data that is input. Each of the convolution layers has a parameter set including a plurality of weights and a plurality of biases of a plurality of filters used for the convolution process.

Next, the training process (S4 in FIG. 3) of the image generation model GN will be described. FIG. 10B is a flowchart of the training process of the image generation model GN. A plurality of parameters used for the operation of the image generation model GN (including a plurality of parameters used for the operation of each of the convolution layers Ve21 to Ve2p and Vd21 to Vd2q) are adjusted by the training. Before the training process, the plurality of parameters are set to initial values such as random values.

In S510, the CPU 110 acquires a plurality of model-training image data for the image generation model GN of a batch size from the nonvolatile memory 130. In S520, the CPU 110 inputs a plurality of model-training image data to the image generation model GN, and generates a plurality of output image data OIg corresponding to the plurality of model-training image data.

In S530, the CPU 110 calculates a loss value using the plurality of model-training image data and the plurality of output image data OIg corresponding to the plurality of model-training image data. Specifically, the CPU 110 calculates an evaluation value indicating a difference between the model-training image data and the corresponding output image data OIg for each model-training image data. The loss value is, for example, a total value of cross entropy errors of component values of each color component for each pixel. For the calculation of the loss value, another known loss function for calculating a loss value corresponding to the difference between the component values, for example, a square error or an absolute error may be used.

In S540, the CPU 110 adjusts the plurality of parameters of the image generation model GN by using the calculated loss value. Specifically, the CPU 110 adjusts the parameters according to a particular algorithm such that the total of the loss value calculated for each model-training image data becomes small. As the particular algorithm, for example, an algorithm using the error backpropagation method and the gradient descent method is used.

In S550, the CPU 110 determines whether a finishing condition of training is satisfied. Similarly to S450 of FIG. 9B, various conditions are used as the finishing condition. The various conditions include that the loss value becomes less than or equal to a reference value, that the amount of change in the loss value becomes less than or equal to a reference value, and that the number of times the adjustment of the parameters of S540 is repeated becomes greater than or equal to a particular number, for example.

In a case where the finishing condition is not satisfied (S550: NO), the CPU 110 returns the processing to S510 and continues the training. In a case where the finishing condition is satisfied (S550: YES), in S560 the CPU 110 stores data of the trained image generation model GN including the adjusted parameters in the nonvolatile memory 130, and ends the training process.

The output image data OIg generated by the trained image generation model GN indicates a reproduction image (not shown) acquired by reconstructing and reproducing the features of the training image SIb as the input image. For this reason, the output image data OIg generated by the trained image generation model GN is also referred to as reproduction image data indicating the reproduction image. The reproduction image (reconstruction image) is approximately the same as the input image (for example, the training image SIb). The trained image generation model GN is trained to reconstruct the features of the training image SIb indicating the normal label L. Thus, it is expected that, when input image data indicating an image of a label including a defect such as scratch or stain (described later) is input to the trained image generation model GN, the reproduction image data generated by the trained image generation model GN indicates an image of a normal label. In other words, the reproduction image is an image acquired by reproducing the normal label in both cases where image data indicating a normal label is input to the image generation model GN and where image data indicating an abnormal label including a defect is input to the image generation model GN.

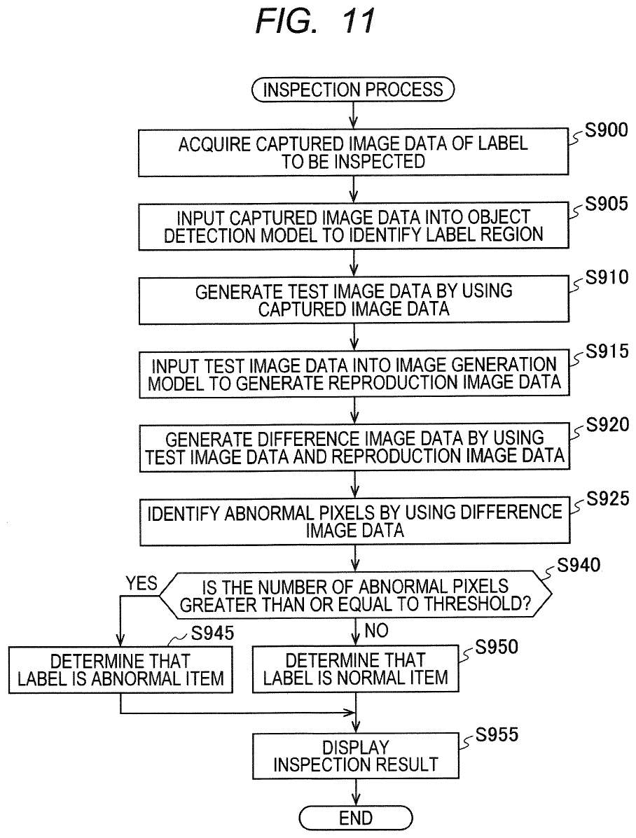

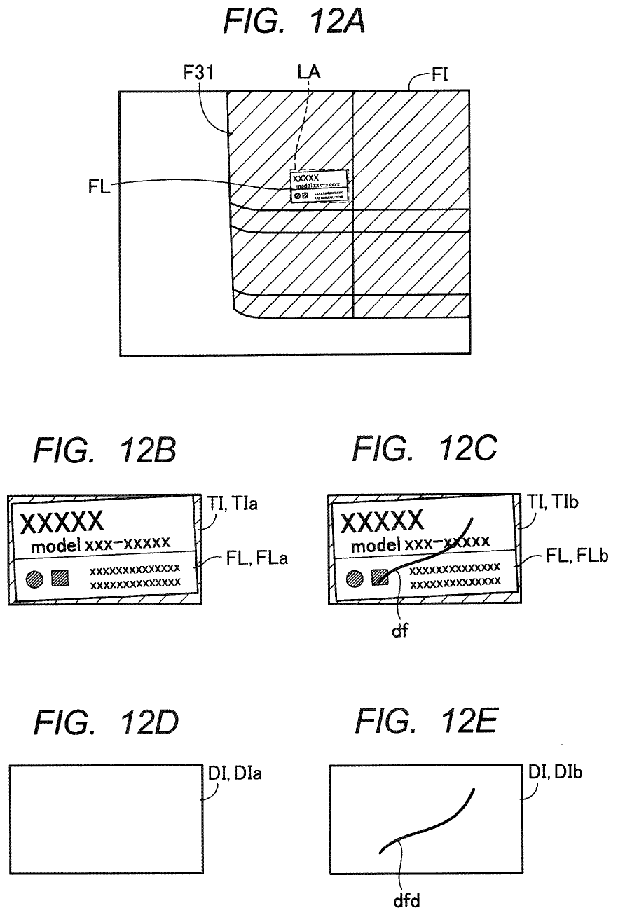

FIG. 11 is a flowchart of the inspection process. FIGS. 12A to 12E are images for explaining the inspection process. The inspection process is a process of inspecting whether the label L to be inspected is an abnormal item including a defect and so on or a normal item not including a defect and so on. The inspection process is performed for each label L. The inspection process is started when a user (for example, an operator of the inspection) inputs a process start instruction to the processing apparatus 100 via the operation interface 150. For example, the user inputs the start instruction of the inspection process in a state where the product 300 to which the label L to be inspected is affixed is arranged at a particular position for capturing an image by using the image capturing device 400.

In S900, the CPU 110 acquires captured image data indicating a captured image including the label L to be inspected (hereinafter, also referred to as an inspection item). For example, the CPU 110 transmits a capturing instruction to the image capturing device 400 to cause the image capturing device 400 to generate captured image data, and acquires the captured image data from the image capturing device 400. As a result, for example, captured image data indicating a captured image FI of FIG. 12A is acquired. The captured image FI is an image showing a front surface F31 of the product and a label FL affixed to the front surface F31. In this way, the front surface of the product and the label shown in the captured image FI are referred to as the front surface F31 and the label FL using reference numerals with “F” added to the head of the reference numerals in order to distinguish from the front surface 31 and the label L (FIGS. 2A and 2B) of the actual product. In some cases, the label FL in the captured image FI includes a defect such as a scratch.

In S905, the CPU 110 inputs the acquired captured image data to the object detection model AN, and identifies a label region LA which is a partial region in the captured image FI and is a region including the label FL. Specifically, the CPU 110 inputs the captured image data as the input image data IIa (FIG. 9A) to the object detection model AN, and generates the output data OD (FIG. 9A) corresponding to the captured image data. The CPU 110 identifies a prediction region from among (S×S×Bn) prediction regions indicated by the output data OD, the prediction region having the confidence Vc greater than or equal to a particular threshold THa and having class information by which it is predicted that the object in the region is the label. The CPU 110 identifies the prediction region as the label region LA. In a case where two or more label regions LA overlapping each other are identified, for example, a known process called “non-maximal suppression” is performed to identify one label region LA from the two or more label regions. For example, in the example of FIG. 12A, the label region LA that includes the entire label FL and substantially circumscribes the label FL is identified in the captured image FI.

In S910, the CPU 110 generates test image data indicating a test image TI by using the captured image data. Specifically, the CPU 110 cuts out the label region LA from the captured image FI to generate the test image data indicating the test image TI. The CPU 110 performs a size adjustment process of enlarging or reducing the test image TI as necessary, and adjusts the size of the test image TI to the size of the input image of the image generation model GN. The test images TI in FIGS. 12B and 12C show an image in the label region LA (that is, an image of the label FL). A label FLa of a test image TIa in FIG. 12B is a normal item and does not include a defect such as a scratch. A label FLb of a test image TIb of FIG. 12C is an abnormal item and includes a linear scratch df.

In S915, the CPU 110 inputs the test image data into the trained image generation model GN, and generates reproduction image data corresponding to the test image data. The reproduction image indicated by the reproduction image data is an image acquired by reproducing the label FL of the input test image TI as described above. For example, regardless of whether the input test image TI is the test image TIa or TIb of FIGS. 12B and 12C, the generated reproduction image is an image including no defect like the test image TIa of FIG. 12B.

In S920, the CPU 110 generates difference image data indicating a difference image DI by using the test image data and the reproduction image data. For example, the CPU 110 calculates a difference value (v1−v2) between a component value v1 of a pixel of the test image TI and a component value v2 of a pixel of the corresponding reproduction image, and normalizes the difference value to a value in the range of 0 to 1. The CPU 110 calculates the difference value for each pixel and each color component, and generates difference image data having the difference value as the color value of the pixel.

FIGS. 12D and 12E show examples of the difference image DI. A difference image DIa of FIG. 12D is a difference image generated when the input image is the test image TIa indicating the normal item of FIG. 12B. The difference image DIa does not include a defect such as a scratch. A difference image DIb of FIG. 12E is a difference image generated when the input image is the test image TIb indicating the abnormal item of FIG. 12C. The difference image DIb includes a scratch dfd corresponding to the scratch df included in the test image TIb. Thus, by referring to the difference image DI, for example, the presence or absence, position, size, and shape of a defect included in the test image TI is identified.

In S925, the CPU 110 identifies abnormal pixels included in the difference image DI by using the difference image data. The abnormal pixel is, for example, a pixel having at least one of the RGB values that is greater than or equal to a threshold TH1, among the plurality of pixels included in the difference image DI. For example, in a case where the difference image DIa of FIG. 12D is a processing target, no abnormal pixel is identified. In a case where the difference image DIb of FIG. 12E is the processing target, a plurality of pixels constituting the scratch dfd are identified as the abnormal pixels.

In S940, the CPU 110 determines whether the number of abnormal pixels identified in the difference image DI is greater than or equal to a threshold TH2. In a case where the number of abnormal pixels is less than the threshold TH2 (S940: NO), in S950 the CPU 110 determines that the label as the inspection item is a normal item. In a case where the number of abnormal pixels is greater than or equal to the threshold TH2 (S940: YES), in S945 the CPU 110 determines that the label as the inspection item is an abnormal item. In S955, the CPU 110 displays the inspection result on the display 140, and ends the inspection process. In this way, it is determined whether the inspection item is a normal item or an abnormal item by using the machine learning models AN and GN.

According to the present embodiment described above, the CPU 110 acquires the label image data indicating the label image LI including the label BL2 and the plurality of source image data indicating the images (source images BI) not including the label L (S27, S30, S20 in FIG. 4). The CPU 110 performs the background generation process using the plurality of particular image data to generate the background image data indicating the background image (S25 in FIG. 4, FIGS. 6A to 6C). The background generation process includes a process of combining a plurality of source images BI, specifically, the four-image arrangement process, the superimposition process, and a combination thereof (FIGS. 6A to 6C). The CPU 110 performs a process including a combining process using the label image data and the background image data, and generates the model-training image data indicating the training images SIa and SIb (FIGS. 8B and 8C) (S35 in FIGS. 4 and S3 in FIG. 3). The combining process includes a process of combining the background image MI and the label image LI by using the background image MI as the background and the label image LI as the foreground (FIG. 8B). The CPU 110 performs training processes by using the model-training image data and the machine learning models (the object detection model AN and the image generation model GN) (S2 and S4 in FIG. 3, FIG. 9B, and FIG. 10B). These training processes include a process (S420 in FIG. 9B and S520 in FIG. 10B) of generating output data (the output data OD and the output image data OIg) by inputting the model-training image data to the machine learning models AN and GN. According to this configuration, the model-training image data to be input to the machine learning models AN and GN are generated by using the label image data and the plurality of source image data. As a result, a plurality of model-training image data indicating the training images SIa and SIb including various backgrounds and label are easily generated. This reduces the burden of preparing the model-training image data to be input to the machine learning models AN and GN. For example, in order to appropriately train the machine learning models AN and GN, several thousands to several tens of thousands of model-training image data may be required. In such a case, for example, if all the model-training image data are generated one at a time by image capturing, a load for generating the model-training image data may become enormous. Even in a case where the model-training image data are generated by combining the background image data and the label image data, if all the background image data are generated one at a time by image capturing, a load for generating the background image data and thus the model-training image data may become enormous. According to the present embodiment, such a disadvantage is suppressed.

According to the above embodiment, the CPU 110 generates the background image data by using the N (N is an integer satisfying 2≤N≤M) source image data to be used selected from the M source image data. The CPU 110 repeats this while changing the combination of the N source image data to be used, thereby generating a plurality of background image data (S20, S25, S55 in FIG. 4). The CPU 110 generates a plurality of model-training image data by using each of the plurality of background image data and the label image data (S35 in FIG. 4). As a result, various background image data are generated while changing the combination of the N source image data selected from the M source image data, and thus a plurality of model-training image data having various background images MI are generated.

According to the above embodiment, the CPU 110 performs the repetitive process of S20 to S25 in FIG. 4 a plurality of times while sequentially increasing the number N of source image data to be used (the use number N) (S65 in FIG. 4), thereby generating the particular number P of background image data and thus model-training image data (S25 and S35 in FIG. 4). As a result, model-training image data having a larger number of various background images MI are generated. For example, even in a case where tens of thousands of model-training image data are required, by using, for example, approximately 20 source image data, tens of thousands of model-training image data having different background images MI are generated

According to the above embodiment, the background generation process performed when the use number N is a particular value (for example, 4) includes the four-image arrangement process and the superimposition process. Thus, even in a case where a relatively small number of source images are used, the variation of the background image MI is increased. In this case, the CPU 110 performs the four-image arrangement processing before the superimposition process (S15 in FIG. 4). The superimposition process requires that the values of the pixels of the background image MI be calculated by using the values of the pixels of the four source images BI. Thus, the processing time required for the superimposition process is longer than the processing time required for the four-image arrangement process of arranging the four background images MI. By performing the four-image arrangement process before the superimposition process, for example, in a case where the particular number P of model-training image data are generated by the four-image arrangement process, it is not necessary to perform the superimposition process. As a result, the time required for generating the P model-training image data may be shortened.

According to the above embodiment, in a case where the background image MI is generated by the process including the four-image arrangement process, the combining process of combining the background image MI and the label image LI (S35 in FIG. 4) is a process of combining the label image LI with the background image MI such that the label image LI is located on the boundary of the plurality of source images BI arranged in the background image MI (FIG. 8B). As a result, the model-training image data is generated such that four types of source images BI (for example, the source images BI3b to BI6b in FIGS. 8B and 8C) are located around the label BL2 in the training images SIa and SIb. As a result, the model-training image data suitable for training of the object detection model AN and the image generation model GN are generated. For example, in the training process of the object detection model AN, the model-training image data group that is used has a variety in the background around the label BL2 to be identified by the object detection model AN. Thus, the object detection model AN learns the feature of the label BL2 while distinguishing the label BL2 from the surrounding background, and thus is trained so as to accurately identify the label region LA where the label BL2 is located. Similarly, in the training process of the image generation model GN, the model-training image data group that is used has a variety in the background around the label BL2 to be reproduced by the image generation model GN. Thus, the image generation model GN learns the feature of the label BL2 while distinguishing the label BL2 from the surrounding background, and thus is trained so as to accurately reproduce the label BL2.

According to the above embodiment, when performing the four-image arrangement process, the CPU 110 randomly determines the dividing point CP defining the four partial regions. Thus, when one source image BI is used for a plurality of background images MI, the aspect ratios of the source image BI included in the background images MI are adjusted to be different from each other. For example, the background image MIb of FIG. 7B and the background image MIc of FIG. 7C include the size-adjusted source images BI4b and BI4c generated based on the same source image BI4 (FIG. 5A). The source image BI4b included in the background image MIb of FIG. 7B and the source image BI4c included in the background image MIc of FIG. 7C have different aspect ratios. This suppresses a plurality of background images MI generated by using the same source image BI being similar to each other. This improves the variety (diversity) of the plurality of model-training image data.

According to the above embodiment, in the combining process (S35 in FIG. 4) of the background image MI and the label image LI, the CPU 110 generates training data including the label region information indicating the label region LA at which the label BL2 is located in the training image SIa, based on the position where the label image LI is combined with the background image MI (S40 in FIG. 4). As a result, since the label region information used for the training process of the object detection model AN is automatically generated, the burden for training the object detection model AN is reduced. In a case where the model-training image data is generated by actually capturing an image of the label L, for example, the operator visually checks the label L in the training image and designates the label region LA to generate the training data. In this case, since work by the operator is required, the burden for training the object detection model AN may increase. Further, in the present embodiment, the label region information indicating the label region LA is generated with higher accuracy than in a case where the operator designates the label region LA. Thus, the object detection model AN is trained so that the object detection model AN identifies the label region LA with high accuracy.

As can be understood from the above description, the label image data of the present embodiment is an example of object image data, the source image data is an example of particular image data, and the model-training image data is an example of input image data. The background generation process of the present embodiment is an example of a first combining process, and the combining process of the background image MI and the label image LI is an example of a second combining process. The training process of the machine learning models AN and GN of the present embodiment is an example of a particular process, the four-image arrangement process is an example of a first process, and the superimposition process is an example of a second process.

While the present disclosure has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the present disclosure, and not limiting the present disclosure. Various changes may be made without departing from the spirit and scope of the disclosure. Thus, the disclosure is intended to embrace all known or later developed alternatives, modifications, variations, improvements, and/or substantial equivalents. Some specific examples of potential alternatives, modifications, or variations in the described invention are provided below.
(1) In the inspection process of the above embodiment, the CPU 110 generates the difference image data by using the test image data and the reproduction image data, and inspects the label by using the difference image data (S920 to S950 in FIG. 11). The present disclosure is not limited to this, and another method may be used as the label inspection method. For example, the CPU 110 may perform label inspection by using a technique called PaDiM. In the PaDiM method, for example, the CPU 110 inputs test image data to the encoder Ve of the image generation model GN to generate feature data of the test image data. The CPU 110 then calculates a Mahalanobis distance between feature data of the test image data and feature data of image data of a plurality of normal labels to perform inspection of the label. The feature data of the image data of the plurality of normal labels is generated in advance, for example, by inputting the image data of the plurality of normal labels to the encoder Ve of the image generation model GN in the inspection preparation process. The PaDiM method is disclosed in, for example, a paper “T. Defard, A. Setkov, A. Loesch, and R. Audigier, “Padim: a patch distribution modeling framework for anomaly detection and localization”, arXiv: 2011.08785 (2020), https://arxiv.org/abs/2011.08785, posting date 17 Nov. 2020”.

In a case where the PaDiM method is used, a plurality of image data generated as the model-training image data for the image generation model GN in the present embodiment may be used as image data of the plurality of normal labels. That is, in the embodiment, the generated input image data is the model-training image data, and the particular process performed using the input image data is the training process, but the present disclosure is not limited to this. For example, the particular process performed using the input image data may be a process of generating feature data of image data of a plurality of normal labels in a case where the PaDiM method is used.

In a case where the PaDiM method is used, an image discrimination model such as ResNet, VGG16, or VGG19 may be used instead of the image generation model GN.
(2) The model-training image data generation process of the above embodiment is an example, and may be changed as appropriate. For example, in the above embodiment, the source image data is captured image data generated by using a digital camera. Alternatively, the source image data may include scan data acquired by reading a document such as a photograph or a magazine using a scanner and so on, or may include image data indicating computer graphics (CG) in which various patterns, characters, and so on are drawn.

In the above embodiment, one background image data and one model-training image data are generated for each of the MCN combinations in which N source image data to be used are selected from M source image data. Alternatively, for example, a plurality of background image data and model-training image data may be generated for each of combinations of N source image data selected randomly. In this case, for example, in a case where the background image data is generated by the four-image arrangement processing, the partial regions in which the source images BI are arranged may be changed among the plurality of background image data. In a case where the background image data is generated by the superimposition process, the composition ratio at which the source images BI are superimposed (that is, a weight of each source image BI when the source images BI are superimposed) may be changed among the plurality of background image data.

In the above embodiment, in a case where the use number N is 2 or 3, the superimposition process is performed as the background generation process. However, instead of the superimposition process or together with the superimposition process, a process of arranging two or three source images BI may be performed. For example, in a case where the use number N is 2, a process of arranging two source images BI in the vertical direction or the horizontal direction may be performed as the background generation process. In a case where the use number N is 3, a process of arranging three source images BI such that one source image BI is arranged in the upper row and two source images BI are arranged in the lower row may be performed as the background generation process.

In a case where the background image MI is generated by the process of arranging the plurality of source images BI, the model-training image data may be generated by arranging the label image LI on the boundary between two or three source images BI in the background image MI, or the model-training image data may be generated by arranging the label image LI at a portion different from the boundary.

In the above embodiment, the superimposition process, the four-image arrangement process, and the process combining these processes are employed as the background generation process. However, one or two of these three processes may be performed.

Further, in a case where the superimposition process and the four-image arrangement process are performed with one use number N as the background generation process (for example, in a case where the use number N is 4), in the present embodiment, the superimposition process is performed after the four-image arrangement process is performed with all of the MCN combinations. Alternatively, the superimposition process may be performed first. Alternatively, the superimposition process and the four-image arrangement process may be performed for one combination, and then the superimposition process and the four-image arrangement process may be performed for the next combination.

In the above embodiment, the dividing point CP is determined randomly in the four-image arrangement process. Alternatively, the dividing point CP may be always the same position (for example, the center of the background image MI), or may be selected randomly or sequentially from a plurality of candidate positions.

In the above embodiment, the label image data is generated by using the artwork image data RD. Alternatively, the label image data may be captured image data generated by capturing an image of the actual label L.
(3) The configurations of the machine learning models AN and GN used in the above-described embodiment are merely examples, and other models may be used. The object detection model may be, for example, a modified YOLO model such as “YOLO v3”, “YOLO v4”, “YOLO v5”, and so on. Other models may also be used, such as SSD, R-CNN, Fast R-CNN, Faster R-CNN, Mask R-CNN, and so on. The image generation model GN is not limited to a normal autoencoder. For example, a VQ-VAE (Vector Quantized Variational Auto Encoder) or VAE (Variational Autoencoder) may be used, or an image generation model included in so-called GAN (Generative Adversarial Networks) may be used.
(4) The object of the inspection target is not limited to a label affixed to a product (for example, a multifunction peripheral, a sewing machine, a cutting machine, a portable terminal, and so on), and may be any object. The object of the inspection target may be, for example, a label image printed on a product. The object of the inspection target may be a product itself or an arbitrary part of the product such as a tag, an accessory, a part, or a mark attached to the product.
(5) The object detection model AN trained by the model-training image data of the above embodiment is used to identify the label region LA in the inspection process of the label L. Alternatively, the object detection model AN may be used for other purposes. For example, the object detection model AN may be used to identify a face region in a captured image in order to perform particular image processing (for example, skin color correction) on the face region in the captured image. In this case, for example, the model-training image data is generated by combining a face image with the background image MI. In this case, too, according to the present embodiment, model-training image data for training the object detection model AN to appropriately identify the face portion in the captured image is easily generated.
(6) In the above-described embodiment, the inspection preparation process and the inspection process are performed by the processing apparatus 100 of FIG. 1. Alternatively, the inspection preparation process and the inspection process may be performed by different apparatuses. In this case, for example, the object detection model AN and the image generation model GN trained by the inspection preparation process are stored in a memory of the apparatus that performs the inspection process. All or some of the inspection preparation process and the inspection process may be performed by a plurality of computers (for example, so-called cloud servers) that communicate with each other via a network. The computer program for performing the inspection process and the computer program for performing the inspection preparation process may be different computer programs.
(7) In each of the embodiment and modifications described above, a part of the configuration realized by hardware may be replaced by software, and conversely, a part or all of the configuration realized by software may be replaced by hardware. For example, all or some of the inspection preparation process and the inspection process may be performed by a hardware circuit such as an ASIC (Application Specific Integrated Circuit).

What is claimed is:

1. A non-transitory computer-readable storage medium storing a set of program instructions for a computer, the set of program instructions, when executed by the computer, causing the computer to:
acquire object image data and a plurality of source image data, the object image data indicating an object image including an object, each of the plurality of source image data indicating a source image not including the object, the plurality of source image data indicating respective ones of a plurality of source images;
perform a first combining process by using the plurality of source image data to generate background image data indicating a background image, the first combining process including combining at least some of the plurality of source images;
perform a second combining process by using the object image data and the background image data to generate input image data indicating an input image, the second combining process including combining the background image and the object image where the background image is background and the object image is foreground; and
perform a particular process by using the input image data and a machine learning model, the particular process including inputting the input image data into the machine learning model and generating output data.

2. The non-transitory computer-readable storage medium according to claim 1, wherein the generating the background image data includes:
selecting N use image data from among M source image data, where N is an integer satisfying 2≤N≤M and M is an integer of 3 or more;
performing the first combining process by using the selected N use image data to generate the background image data; and
performing a repetition process of repeating the first combining process while changing a combination of the N use image data to generate a plurality of background image data; and
wherein the generating the input image data includes generating a plurality of input image data by using the object image data and the plurality of background image data.

3. The non-transitory computer-readable storage medium according to claim 2, wherein the generating the background image data includes performing the repetition process a plurality of times while sequentially incrementing the number N, thereby generating a particular number of background image data.

4. The non-transitory computer-readable storage medium according to claim 3, wherein the first combining process performed in a case where the number N is a particular value includes:
a first process of generating the background image data indicating the background image in which a plurality of source images are arranged; and
a second process of generating the background image data indicating the background image including a superimposed region in which at least some of the plurality of source images are superimposed, a value of a pixel in the superimposed region being calculated by using both a value of a pixel of one source image and a value of a pixel of another source image; and
wherein the first process is performed before the second process.

5. The non-transitory computer-readable storage medium according to claim 1, wherein the first combining process includes generating the background image data indicating the background image in which a plurality of source images are arranged; and
wherein the second combining process includes combining the object image with the background image such that the object image is located on a boundary of the plurality of source images arranged in the background image.

6. The non-transitory computer-readable storage medium according to claim 1, wherein the first combining process includes generating the background image data indicating the background image in which a plurality of source images are arranged;
wherein the generating the background image data includes generating a plurality of background image data including first background image data indicating a first background image and second background image data indicating a second background image, the first background image including a first size-adjusted source image, the second background image including a second size-adjusted source image; and
wherein the first size-adjusted source image and the second size-adjusted source image are generated based on a same source image, the first size-adjusted source image and the second size-adjusted source image having different aspect ratios.

7. The non-transitory computer-readable storage medium according to claim 1, wherein the particular process is a training process of training the machine learning model by using a plurality of input image data.

8. The non-transitory computer-readable storage medium according to claim 7, wherein the machine learning model is an object detection model configured to detect a region at which an object is located in an image;
wherein the set of program instructions, when executed by the computer, causes the computer to further perform:
generating region information indicating a region at which the object is located in the input image, based on a position at which the object image is arranged in the background image in the second combining process; and
wherein the training process is performed by using the plurality of input image data and a plurality of region information corresponding to the plurality of input image data.

9. The non-transitory computer-readable storage medium according to claim 5, wherein the object image is arranged on a dividing point defining the boundary of the plurality of source images arranged in the background image; and
wherein the plurality of source images are arranged in partial regions defined by a first dividing line and a second dividing line, the first dividing line passing through the dividing point and extending in a vertical direction, the second dividing line passing through the dividing point and extending in a horizontal direction.

10. The non-transitory computer-readable storage medium according to claim 9, wherein a position of the dividing point is determined randomly within a particular range set in the background image; and
wherein the particular range is a rectangular range having a same center as a center of the background image and having a width and a height of a particular ratio of a width and a height of the background image.

11. A processing method comprising:
acquiring object image data and a plurality of source image data, the object image data indicating an object image including an object, each of the plurality of source image data indicating a source image not including the object, the plurality of source image data indicating respective ones of a plurality of source images;
performing a first combining process by using the plurality of source image data to generate background image data indicating a background image, the first combining process including combining at least some of the plurality of source images;
performing a second combining process by using the object image data and the background image data to generate input image data indicating an input image, the second combining process including combining the background image and the object image where the background image is background and the object image is foreground; and
performing a particular process by using the input image data and a machine learning model, the particular process including inputting the input image data into the machine learning model and generating output data.

12. A processing apparatus comprising:
a controller; and
a memory storing a set of program instructions, the set of program instructions, when executed by the controller, causing the processing apparatus to:
acquire object image data and a plurality of source image data, the object image data indicating an object image including an object, each of the plurality of source image data indicating a source image not including the object, the plurality of source image data indicating respective ones of a plurality of source images;
perform a first combining operation by using the plurality of source image data to generate background image data indicating a background image, the first combining operation including combining at least some of the plurality of source images;
perform a second combining operation by using the object image data and the background image data to generate input image data indicating an input image, the second combining operation including combining the background image and the object image where the background image is background and the object image is foreground; and
perform a particular operation by using the input image data and a machine learning model, the particular operation including inputting the input image data into the machine learning model and generating output data.
